(19) United States
(12) Patent Application Publication
(10) Pub. No.: US 2018/0001821 A1
(43) Pub. Date: Jan. 4, 2018

(54) ENVIRONMENT PERCEPTION USING A SURROUNDING MONITORING SYSTEM

(71) Applicant: Intel IP Corporation, Santa Clara, CA (US)

(72) Inventors: Koba Natroshvili, Waldbronn (DE); Stephan Leenders, Karlsruhe (DE)

(73) Assignee: Intel IP Corporation, Santa Clara, CA (US)

(21) Appl. No.: 15/198,561

(22) Filed: Jun. 30, 2016

(51) Int. Cl. B60R 1/00; G06K 9/62; G06K 9/00

(52) U.S. Cl. CPC B60R 1/00; G06K 9/00791; G06K 9/6201; B60R 2300/607; B60R 2300/806; G06T 2200/04

(57) ABSTRACT

An apparatus for environment perception using a monitoring system is described herein. The apparatus includes a plurality of sensors, wherein the plurality of sensors is to collect data. The apparatus also includes a controller to estimate motion based on the data and data from a plurality of cameras, wherein the data from the plurality of cameras is processed simultaneously. Additionally, the apparatus includes a matching unit to perform feature matching using the motion estimation and a perception unit to determine a 3D position of points in the environment.

### BACKGROUND ART

Monitoring systems may be integrated into a number of devices. For examples, monitoring systems are often included in vehicles, buses, planes, trains, and other people transportation systems. Monitoring systems typically include a plurality of cameras. A vehicle monitoring system may include a plurality of cameras that are to function as outside mirrors, and can be used to create a top view to assist the driver in in various maneuvers, such as parking scenarios. In the case of a moving camera system, the structure of the surrounding environment may be constructed using motion estimation algorithms.

### BRIEF DESCRIPTION OF THE DRAWINGS

FIG. 1 is a block diagram of an electronic device for environment perception using a monitoring system;

FIG. 2 is a block diagram of a method for environmental perception;

FIG. 3A is an illustration of finding feature points in a first frame and a second frame;

FIG. 3B is an illustration of a data structure;

FIG. 3C is an illustration of averaging observations;

FIG. 4 is a motion model;

FIG. 5 is a process flow diagram of a method for environment perception using a surrounding monitoring system;

FIG. 6 is an illustration of a plurality of graphs simulating motion; and

FIG. 7 is a block diagram showing a medium that contains logic for environment perception using a surrounding monitoring system.

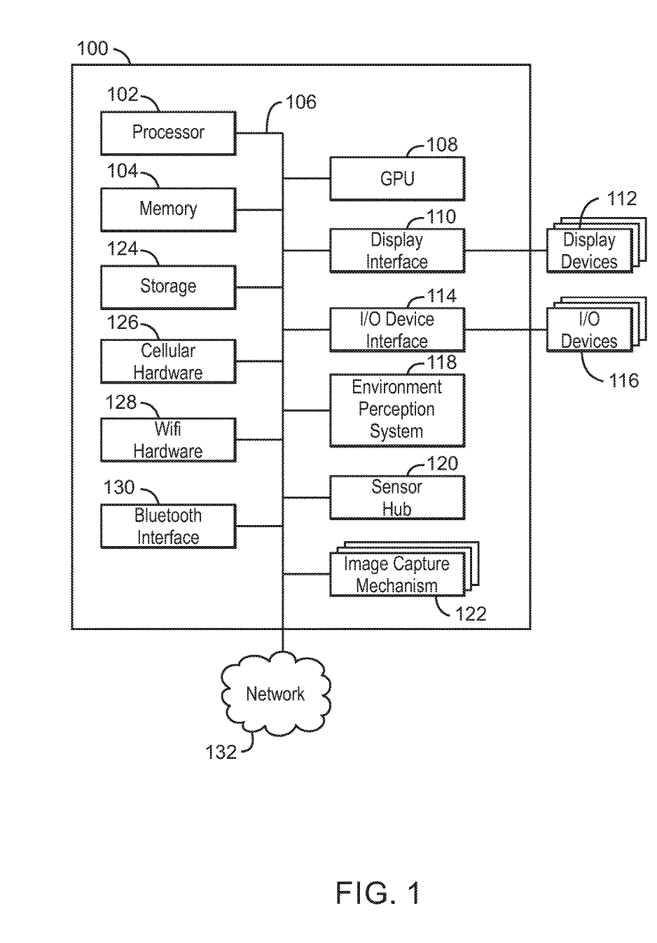

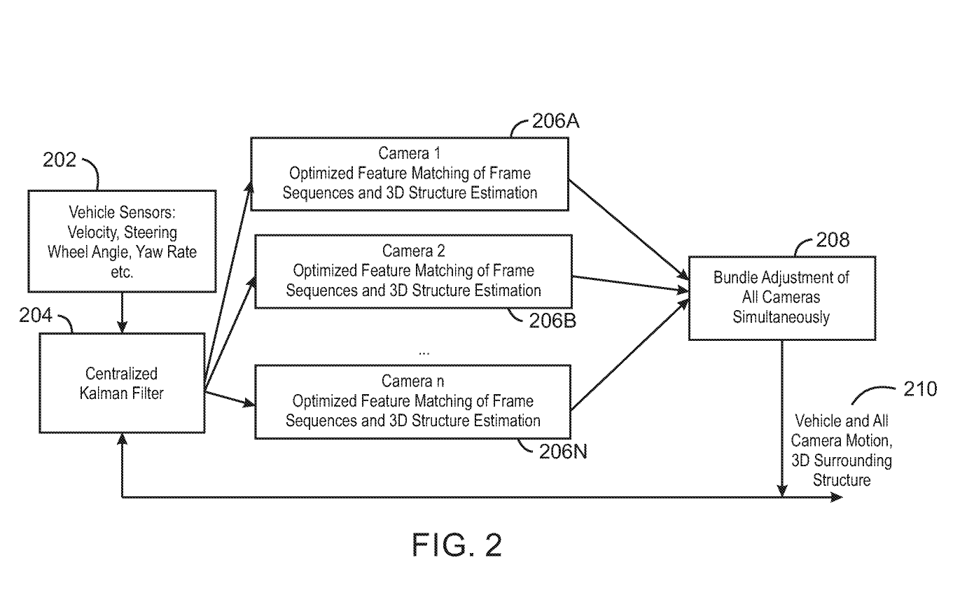

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE ASPECTS

As discussed above, a monitoring system can construct a representation of the surrounding environment via motion estimation algorithms. In some cases, a set of images obtained from a camera system may be used to find corresponding or matching feature points in each image to construct a three dimensional (3D) model of the environment captured by the images. Typical 3D structure estimations involve a fundamental matrix calculation with a random approach finding correlated points. When randomly calculating the fundamental matrix, the probability of having a subset of points with no spurious correlated points is used to calculate an initial fundamental matrix. A fundamental matrix calculation using a random approach can have a high calculation time with a relatively low precision of the resulting 3D structure.

Embodiments described herein relate generally to techniques for environment perception using a monitoring system. A plurality of sensors may be used to collect data. A controller may be used to estimate motion based on the data and data from a plurality of cameras, wherein the data from the plurality of cameras is processed simultaneously. Feature matching may be performed using the motion estimation data, and a 3D position of points in the environment may be determined. The 3D points can be used to render the surrounding environment.

In embodiments, data from various sensors is fused with the output of camera based motion estimation. The fused data is input to a Kalman filter to obtain a more accurate estimate of the motion of the car that is based on the fused sensor data and camera based motion estimation. In embodiments, instead of a least square method, 3D triangulation is performed analytically. The more accurate motion data is used to optimize the feature matching process and determine a rough 3D position of the points. Several frame sequences from all cameras, taken simultaneously, may be processed in this manner optimized in a single step with Combined Sparse Bundle Adjustment (CSBA). The results of the CSBA are fed back to the Kalman filter as feedback input to refine the motion estimation for the next frame. As a side effect, the 3D positions are optimized as well.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

FIG. 1 is a block diagram of an electronic device for environment perception using a monitoring system. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads. For example, the GPU 108 may include an engine that processes data from the image capture mechanism 122.

The CPU 102 can be linked through the bus 106 to a display interface 110 configured to connect the electronic device 100 to a display device 112. The display device 112 can include a display screen that is a built-in component of the electronic device 100. The display device 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

The electronic device 100 also includes an environment perception system 118. The environment perception system may include a combination of hardware and software that is to perceive the surrounding environment and/or generate a 3D structure estimation by at least fusing data from a plurality of sensors 120 and a plurality of cameras or image capture mechanisms 122. Accordingly, the electronic device 100 may include a plurality of sensors or sensor hub 120. In embodiments, the environment perception system 118 may include a plurality of sensors 120. The sensors may be any type of sensor, including sensors that sense motion. Accordingly, the sensors may include, but are not limited to vehicle sensors and are typically present in most vehicles. In embodiments, the sensors include velocity sensors, steering motion sensors, and the like. The data from the sensors may be provided to a Kalman filter to make an initial estimate of the motion of a vehicle. Triangulation may be done analytically when obtaining a point Rₓ as described below. The initial rough motion estimate can be used to optimize a feature matching process and several frame sequences from all cameras 122 are simultaneously processed and optimized using a combined sparse bundle adjustment (CSBA). The results of the CSBA may be fed to the Kalman filter, where the motion estimation for the next frame is refined. Additionally, 3D positions of the surrounding environment are optimized during this process as well. In embodiments, the present techniques reduce calculation time. Additionally, by fusing the information of all cameras with the vehicle sensors, the precision of the vehicle motion and 3D structure is increased.

The electronic device may also include a storage device 124. The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, GPU 108, or any other processors that may be included in the electronic device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union-Radio communication Sector (ITU-R)). In this manner, the electronic device 100 may access any network 132 without being tethered or paired to another device, where the network 132 is a cellular network.

The CPU 102 may also be linked through the bus 106 to WiFi hardware 128. The WiFi hardware is hardware according to WiFi standards (standards promulgated as Institute of Electrical and Electronics Engineers' (IEEE) 802.11 standards). The WiFi hardware 128 enables the electronic device 100 to connect to the Internet using the Transmission Control Protocol and the Internet Protocol (TCP/IP), where the network 132 is the Internet. Accordingly, the electronic device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the electronic device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others. While one network is illustrated, the electronic device 100 can connect with a plurality of networks simultaneously.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

Typically, motion estimation algorithms can be ineffective if the motion is small as traditional motion estimation algorithms calculate features in a plurality of images. In embodiments, the present techniques use vehicle sensor data for an initial motion estimation, which yields faster results computationally as well as more reliable results when compared to a fundamental matrix calculation based on random approaches. In the case of some motion, the three dimensional (3D) structure can be obtained by structure from motion estimation algorithms. Typically, these motion estimation algorithms have problems with accurate motion representation if the motion is very small, especially if motion is in the direction of the camera axis. Additionally, typical motion estimation algorithms use a fundamental matrix calculation and finds the feature couples by an extensive search.

Motion algorithms traditionally include initially calculating features in two images. In embodiments, these may include features can be corners, scale-invariant feature transform (SIFT), speeded up robust features (SURF), features from accelerated segment test (FAST), binary robust invariant scalable keypoints (BRISK), or others. The features in each of the images may then be matched. At this point, no multiple view geometry is typically known, therefore this matching search is quite intensive in computation. Once the features are mapped across images, a fundamental matrix may be calculated. In embodiments, the fundamental matrix is the fundamental matrix is a 3×3 matrix that relates corresponding points in a pair of images. Thus, each point in the matrix satisfies a relationship where x and x′ describe corresponding points in a stereo image pair, and F(x) describes a line (an epipolar line) on which the corresponding point x′ on the other image must lie. That means, for all pairs of corresponding points, the following holds x′^{T} F(x)=0, where ( )^{T} represents the transpose of a vector or matrix, x is a point in a first image of a stereoscopic pair, x′ is a point in a second image of a stereoscopic pair. The epipolar line is a line that is a function of the position of a point in 3D space, where the point appears as a point in one image of the stereoscopic pair, and as a line in the second image of a stereoscopic pair.

Fundamental matrix calculations may be based on random methods like random sample consensus (RANSAC), m-estimator sample and consensus (MSAC), least trimmed squares (LTS), and the like. In embodiments, the technique used for the fundamental matrix calculations is dependent on the percentage of outliers that occur during feature matching. Feature matching can consume a large amount of power depending on the needed computations. The 3D structure is calculated using a direct linear transformation (DLT) algorithm and the final results can be optimized via a sparse bungle adjustment, which is a nonlinear optimization method. In embodiments, motion estimation using sensor information can reduce the computation time and processing power necessary for environmental perception.

FIG. 2 is a block diagram of a method 200 for environmental perception. The method 200 uses sensor data, such as vehicle sensor data 202 to reduce the time and power used for motion estimation. In embodiments, the sensor data is vehicle sensor data used to perceive the environment surrounding a vehicle. The sensor measurements available from the vehicle (for example in most cars velocity, steering wheel change rate or yaw rate can be obtained from a sensor) are fused in a centralized Kalman Filter 204 to determine a rough car motion. The rough car motion can be converted to all camera motions and is used during the optimized feature matching process to determine feature couples and a rough structure. Put another way, the rough car motion is processed to obtain a rough car motion from each camera viewpoint. In the example of FIG. 2, cameras 206A, 206B, . . . , 206N are illustrated. For each camera, feature matching, motion estimation, and a 3D structure estimation is performed. The less precise and less accurate car movement and the structure from the cameras are optimized with via the bundle adjustment (CSBA) 206. The refined car motion 210 may be rendered for a user and fed back to the Kalman Filter 204, where it is fused to optimize the next rough car motion prediction in an iterative fashion.

Accordingly, the feature matching performed by each of the frame from the cameras 206A, 206B, . . . , 206N can be optimized using a feedback system to the centralized Kalman filter 204. Although a Kalman filter is described, any filter that fuses data may be used. To optimize the feature matching, the estimated motion of the camera frames is output to the Kalman filter. This information is used to optimize the process of finding feature couples.

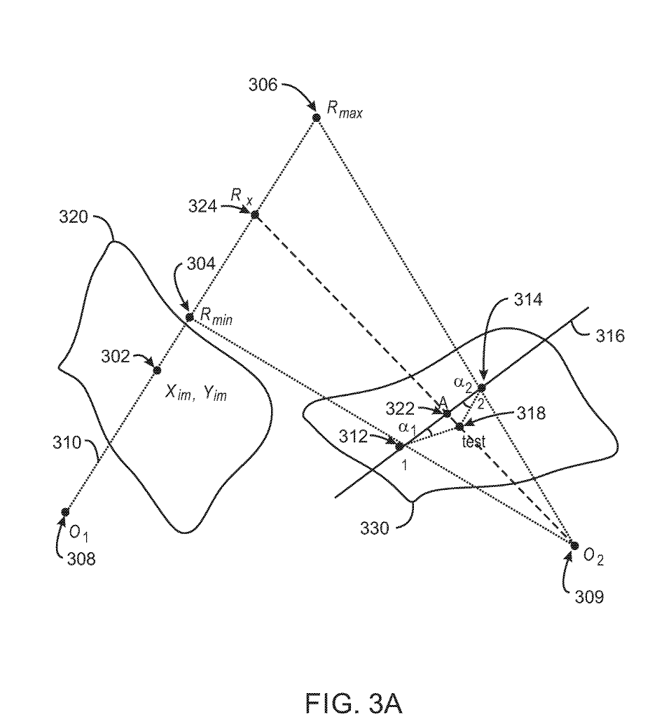

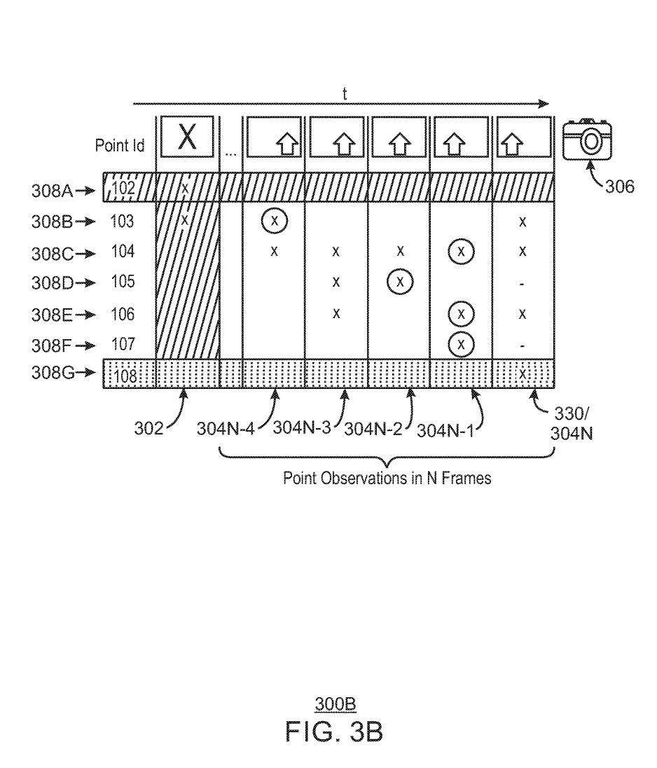

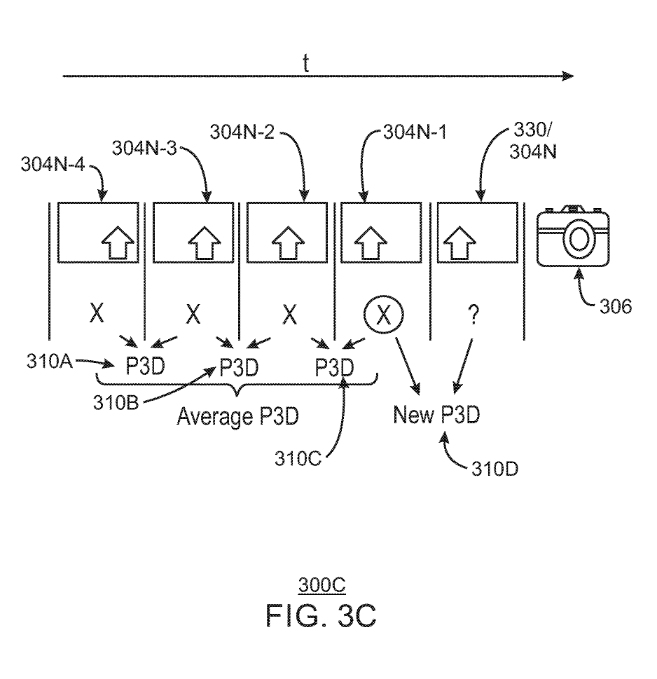

FIG. 3A is an illustration of finding feature points in a first frame 320 and a second frame 330. In an example, assume that in a first frame 320 a feature is given as (xᵢₘ, yᵢₘ) coordinates 302. The point (xᵢₘ, yᵢₘ) is to be matched with a point on the second frame 330. The points O₁ 308 and O₂ 309 represent the appropriate camera centers for each respective frame. Through epipolar geometry, the corresponding couple in the second frame 330 for (xᵢₘ, yᵢₘ) appears as a line 316 not a single point. This results in an ambiguity in matching the point in the first frame 320 to a point in the second frame 330. All 3D points in the second frame 330 potentially corresponding to the point (xᵢₘ, yᵢₘ) may be in a range from Rᵢₘ, 304 and Rₘₐₓ 306. In FIG. 3A, Rₘᵢₙ 304 and Rₘₐₓ 306 are distances. In embodiments, the distances Rₘᵢₙ 304 and Rₘₐₓ 306 may be selected according to a pre-determined range. When the scene is limited to this particular range, the length of the epipolar line 316 is reduced along with the appropriate matching error.

When the range is applied to the ray 310, each of Rₘᵢₙ 304 and Rₘₐₓ result in two corresponding points on the ray 310. The first frame 320 is taken as a reference. Therefore, for each of the points Rₘᵢₙ 304 and Rₘₐₓ, a z-coordinate is equal to Rₘᵢₙ and Rₘₐₓ. The x- and y-coordinates for both points will be same, as the points lie along the ray 310. Finally the 3D coordinates of points are given as

$$( \begin{matrix}{x}_{im} \\ {y}_{im} \\ {R}_{m i n}\end{matrix} ) and ( \begin{matrix}{x}_{im} \\ {y}_{im} \\ {R}_{ma x}\end{matrix} ) .$$

These points from the first frame 320 are projected in the second frame 330 using a projection matrix estimated from the Kalman filter. A point 312 and 314 of the second frame 330 correspond to Rₘᵢₙ 304 and Rₘₐₓ 306 of the first frame 320. In embodiments, the line 316 line is an epipolar line. The fundamental matrix constraint says that the coupled, matching point, projected from frame 320, should lie on line 316. This requirement may be modified by the following constraints:

|test_A|<threshold (Eqn. 1)

where |test_A| is a distance between test and A points. A is the projection of test point into epipolar line, and test is a point believed to be near to or the actual corresponding point.

The second constraint is as follows:

cos α₁>0, cos α₂>0, where α₁ is the 2_1 test angle and α₂ is the 1_2_test angle as illustrated in FIG. 3A.

These constrains guarantee that the test point 318 is close to epipolar line and lies in the projection range of Rₘᵢₙ 304 and Rₘₐₓ 306. To optimize the matching process a grid search method is used. The grid search may be an exhaustive search through a specified subset of the feature space. In a grid search, each feature has a 2D coordinate on the image plane. If the image is subdivided into rectangular regions, each feature can be assigned to one of these regions. This results in multiple lists of features, where each feature represents one rectangular region. Because the line segment from point 312 to point 314 is known, the number of features can be reduced by only matching features that are in the rectangles that cross the line segment from point 312 to point 314. Thus, in embodiments, the feature at point (xᵢₘ, yᵢₘ) 302 does not need to be matched against all features of the frame 330. Instead, only the subset of features or candidate features as described above are used for matching.

The descriptor vectors of all candidate features are compared using a sum of absolute differences (SAD), sum of squared differences (SSD), or any other feature specific metric against a certain threshold. For determining if two features look similar or are a match, a small part of the image around the feature coordinate is cut out. This region is referred to as the descriptor, and consists of a vector of intensity values. For some feature computation techniques (e.g. SIFT or BRISK) this region is not just a part of the image but will be preprocessed in a certain manner. Such techniques can be used to compare the descriptors. In the case that multiple test points fulfill all the above constraints, the one that best conforms to the descriptor region is considered a match.

An assumption may be made that assumes the correct feature couple is found, and the couple may be triangulated in order to obtain the 3D structure. In embodiments, triangulation may be performed in an analytical fashion. For the point test 318, the point A 322 may be the projection of test 318 to the epipolar line 316. Finding Rₓ 324, which is the intersection of the line O₁ 308 to (xᵢₘ, yᵢₘ) 302 with test 318 to A 322, is done in the following manner:

First,

$${P}_{2} = \frac{( \begin{matrix}{x}_{Im} * {R}_{m i n} \\ {y}_{Im} * {R}_{m i n} \\ {z}_{Im} * {R}_{m i n} \\ 1\end{matrix} )}{{z}_{m i n}} = ( \begin{matrix}{x}_{m i n} \\ {y}_{m i n} \\ 1\end{matrix} ) , \qquad ( Eqn . 2 )$$

where P₂ is the projection matrix for camera 2. It includes camera intrinsics, rotation and translation. P₂ is calculated by camera motion and is an output of combined sparse bundle adjustment (CSBA).

$$\begin{matrix}{x}_{m i n} \\ {y}_{m i n}\end{matrix}$$

are image coordinates of points 312 and zₘᵢₙ is the corresponding depth.

Similarly,

$${P}_{2} = \frac{( \begin{matrix}{x}_{Im} * {R}_{ma x} \\ {y}_{Im} * {R}_{ma x} \\ {z}_{Im} * {R}_{ma x} \\ 1\end{matrix} )}{{z}_{ma x}} = ( \begin{matrix}{x}_{ma x} \\ {y}_{ma x} \\ 1\end{matrix} ) , \qquad ( Eqn . 3 )$$

where

$$\begin{matrix}{x}_{ma x} \\ {y}_{ma x}\end{matrix}$$

are image coordinates of points 314 and zₘₐₓ is the corresponding depth.

$${P}_{2} = \frac{( \begin{matrix}{x}_{Im} * {R}_{x} \\ {y}_{Im} * {R}_{x} \\ {z}_{Im} * {R}_{x} \\ 1\end{matrix} )}{{z}_{x}} = ( \begin{matrix}{x}_{A} \\ {y}_{A} \\ 1\end{matrix} ) ,$$

Rₓ is the distance to the 3D point which corresponds to the test 318 point from the frame 330 or frame 2. zₓ is the corresponding depth.

Next the notation

$$a = \frac{1 \_ A}{1 \_ 2}$$

is introduced. The point Rₓ may be obtained analytically via the following equation, instead of using the least squares:

$${R}_{x} = \frac{a * {z}_{ma x} * {R}_{ma x} + ( 1 - a ) * {z}_{m i n} * {R}_{m i n }}{a * {z}_{ma x} + ( 1 - a ) * {z}_{m i n}} \qquad ( Eqn . 4 )$$

In embodiments, for further improvements a method for matching features between multiple frames may be implemented where instead of only taking features from the neighboring frames into consideration, a list of all features of a fixed number of past frames that are matched against the new frame is obtained. If a feature couple is determined with the above described method it can still be matched with future frames. In embodiments, this method guarantees that that the feature couples which are not in the neighboring frames are also considered.

Matching features via multiple frames begins similar to the feature matching process described with respect to FIG. 3A. Specifically, a new frame arrives, such as frame 330. For all features of the frame 320, a line segment (for example, point 312 to point 314) is generated and projected onto the frame 330. Each line segment is used to generate a subset of possible matches, where the subsets are generated according to the grid search described above. For each feature of each subset, the distance to the line is computed as |test_A|. All features that have a larger distance to the line than a defined threshold are not considered as a match, and the remaining candidates are compared by their appearance using descriptors. For all features in both images, a descriptor vector of intensity values is extracted, and the vectors are compared. The result of comparing two of these vectors is a single distance value that describes the similarity of the descriptors. Candidates that have a larger distance than a defined threshold are not considered for further processing. If there is more than one remaining candidate, the one with the shorter distance is selected. After these processing steps, several features of frame 320 will have a match in frame 330. For most of these matches, the described procedure will find the same feature point in both images. However, false positives may still remain.

To eliminate the remaining false positives, multiple frames will be analyzed. In doing so, feature matching as described thus far may be slightly adjusted. Because multiple old frames exist, the matching algorithm as described herein operates on a data structure such as the tracking buffer illustrated in FIG. 3B.

FIG. 3B is an illustration of a data structure 300B. The data structure 300B may be a tracking buffer, and includes data from several frames 302 and 304. The frames may be obtained from a camera 306. In particular, the left column 302 represents the oldest frame in the buffer that has just been released. The right-most column represents the latest frame 330/304N. A fixed number of N old frames will be taken into account when feature matching across multiple frames, and are illustrated at the remaining columns 304N-4, 304N-3, 304N-2, and 304N-1.

Each row in the represents a potential 3D point 308 that is part of the resulting 3D structure. Specifically, rows 308A, 308B, 308C, 308D, 308E, 308F, and 308G each represent a point in the 3D structure. An “X” in the line for each column indicates an observation of that point in the column's respective frame. A point is considered as part of the final 3D structure if the point was observed in a predefined minimum number of frames.

In finding such an observation for each frame, the tracking buffer may be cleaned. Cleaning the tracking buffer refers to deleting the entries for the last frame. After cleaning, some of the rows will not have any observation entry. These rows with no observation will be deleted. In the example of FIG. 3B, the row 308A does not have an observation entry and can be deleted. In this example, the frame at column 302 can be deleted as well as it is considered a part of the last frame matching procedure across multiple frames.

In a next step, for each point 308, the latest, most recent observation with respect to time observations is selected from each line, as marked with a circle. The respective point for each circled observation is projected as a line segment into the latest frame 304N according to the technique described in FIG. 3A. In the example of FIG. 3A, the latest frame is frame 330. This is projection is possible since the relative position and orientation of each frame is computed from the motion model and optimized with CSBA in the previous computation steps.

For each projected line segment and the respective frame, the line segment is used to generate a subset of possible matches, where the subsets are generated according to a grid search. For each feature of each subset, the distance to the line is computed and all features that have a larger distance to the line than a defined threshold are not considered as a match. The remaining candidates are compared by their appearance using descriptor vectors, and candidates that have a larger distance than a defined threshold are not considered for further processing. If there is more than one remaining candidate, the one with the shorter distance is selected.

If a candidate is found for an observation, a last filter is applied to decide if the candidate is written into the buffer. As illustrated in FIG. 3C, for each pair of adjacent observations for a particular point, the 3D position is computed by the Eqn. 4. In this manner, multiple 3D points are computed from the old frames and averaged, resulting several points 310. As illustrated, the observations result in points 310A, 310B, and 310C. These points may be averaged to obtain a final matching point 312. The observation in the new frame 304N and the last frame 304N-1 also results in a 3D point 310D. If the distance between the new point 310D and the average 3D point 312 exceeds a certain threshold, the point 310D is not considered as a match.

Finally, if a feature of frame 330/304N cannot be matched to the features of the old frames 304N-4, 304N-3, 304N-2, and 304N-1, the feature results in a new row in the tracking buffer, as illustrated by rom 308G. Using the described matching technique with multiple frames, it is possible to eliminate nearly all false positives. Additionally, the data structure 300B gets denser with time because multiple frames are involved, resulting in the chance that a feature can be matched increasing. Finally, the accuracy of the resulting structure increases due to the fact that the high number of observations compensate measurement deviations.

The present techniques achieve the following goals. First, the matching, outlier filtering and triangulation processes are combined into one, single routine. The grid search approach enables a drastic increase in the speed of feature matching. Due to region filtering, outliers may be filtered more effectively than during a traditional fundamental matrix computation. As noted above, traditional fundamental matrix calculations are mostly based on the random methods that are quite time consuming. Moreover, the feature tracking system described herein also makes it possible to filter points from their number of observations. Because multiple 3D points are generated for each observation pair this information can also be used to filter outliers or average the point. After the camera data has been fused as described above, all frames and cameras are optimized with CSBA. In embodiments, due to the fact that the cameras are static on the vehicle there is an additional constraint on the system. The rigid system can be used to optimize the car movement instead of optimizing each camera separately.

In embodiments, the centralized Kalman filter may be used to fuse the CBSA results and vehicle sensor data. In embodiments, the vehicle motion may be modeled as a simple bicycle model.

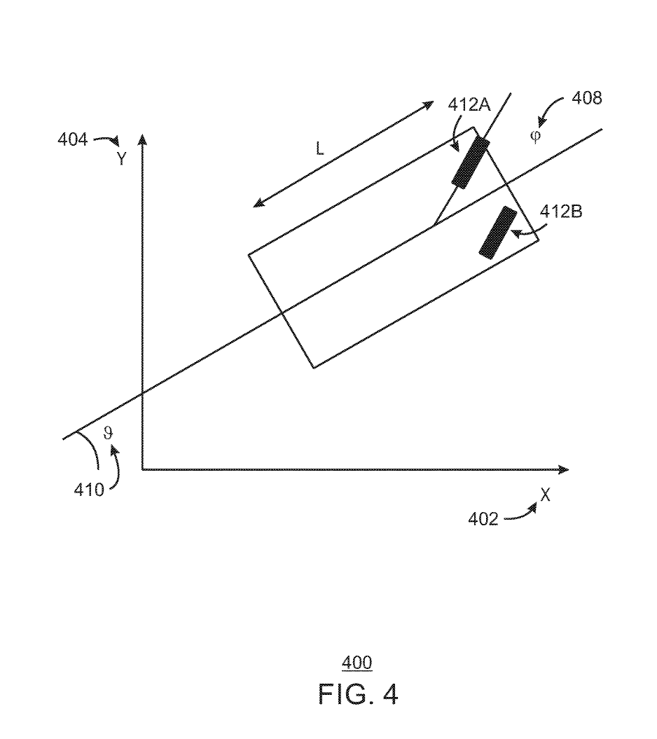

FIG. 4 is a motion model 400. The x-axis represents a first 2D coordinate 402 and the y-axis represents a second 2D coordinate 404. The main dynamic equations of the model 400 are as follows:

$$x = v * cos ( ϑ )$$

$$y = v * sin ( ϑ )$$

$$ϑ = \frac{v}{L} tan ( ϕ )$$

where x and y are coordinates, v is the vehicle velocity 406, φ is the steering wheel angle 408, and θ is the vehicle heading angle 410. In FIG. 4, L represents the distance between vehicle axes, and the rectangles 412A and 412B represent positions of the front wheels.

The state vector x=(x, y, \dot{x}, \dot{y}, θ, \dot{θ}, φ)^{T}=(x₁, x₂, x₃, x₄, x₅, x₆, x₇)^{T}. For a nonlinear filter, the state transition equation has the following form:

\dot{x}=ƒ(x)

where ƒ is state transition function.

In a nonlinear Kalman filter, instead of a state transaction matrix the present techniques employ a square Jacobean matrix and its determinant Jacobean as follows:

$$\frac{\partial f}{\partial x} = [ \begin{matrix}0 & 0 & 1 & 0 & 0 & 0 & 0 \\ 0 & 0 & 0 & 1 & 0 & 0 & 0 \\ 0 & 0 & 0 & 0 & 0 & 0 & 0 \\ 0 & 0 & 0 & 0 & 0 & 0 & 0 \\ 0 & 0 & \frac{{x}_{3}}{L \cdot \sqrt{{x}_{3}^{2} + {x}_{4}^{2}}} tan {x}_{7} & \frac{{x}_{4}}{L \cdot \sqrt{{x}_{3}^{2} + {x}_{4}^{2}}} tan {x}_{7} & 0 & 0 & \frac{\sqrt{{x}_{3}^{2} + {x}_{4}^{2}}}{L \cdot } \frac{1}{{cos}^{2} {x}_{7}} \\ 0 & 0 & 0 & 0 & 0 & 0 & 0 \\ 0 & 0 & 0 & 0 & 0 & 0 & 0\end{matrix} ]$$

In the initial implementations, the present techniques assume that the motion measurements are z₁=(v, \dot{θ})^{T}. The motion measurements are obtained from the vehicle odometery sensors and are velocity 406 and heading angle 410 change. For the measurement function h the corresponding Jacobean is given as:

$$\frac{\partial h}{\partial z} = [ \begin{matrix}0 & 0 & \frac{{v}_{x}}{v} & \frac{{v}_{y}}{v} & 0 & 0 & 0 \\ 0 & 0 & \frac{{v}_{x}}{L \cdot v} tan ϕ & \frac{{v}_{x}}{L \cdot v} tan ϕ & 0 & 0 & \frac{{v}_{x}}{L \cdot {cos}^{2} ϕ}\end{matrix} ]$$

From the CSBA, the present techniques are used to obtain the optimized vehicle position and motion of each camera which are converted to the vehicle coordinate system. In embodiments, another measurement vector will be output of the CSBA. The corresponding measurement function h_{bun} will be linear and following will be valid:

$$\frac{\partial {h}_{bun}}{\partial z} = [ \begin{matrix}0 & 0 & 0 & 0 & 0 & 0 & 1 \\ 0 & 0 & 0 & 0 & 0 & 1 & 0 \\ 0 & 0 & 0 & 0 & 1 & 0 & 0\end{matrix} ]$$

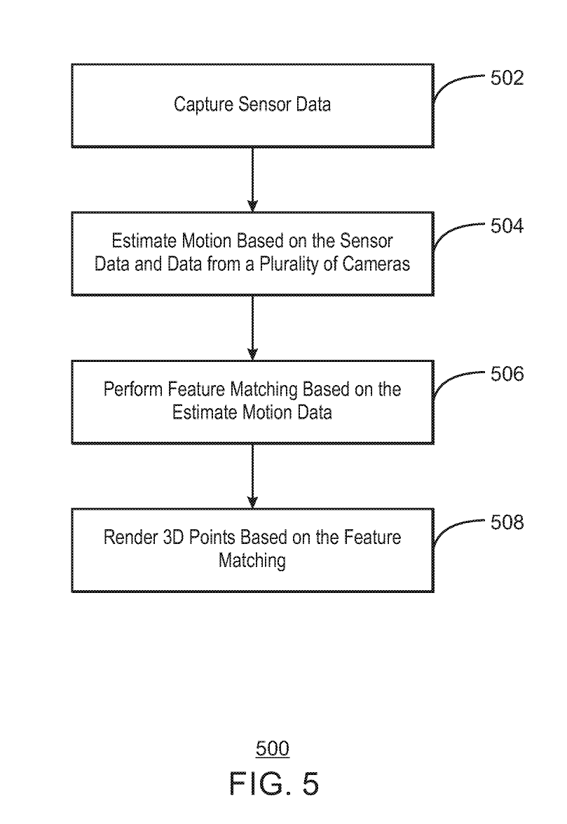

FIG. 5 is a process flow diagram of a method 500 for environment perception using a surrounding monitoring system. At block 502, sensor data is collected. At block 504, motion may be estimated based on the sensor data and data from a plurality of cameras. In embodiments, the data from the plurality of cameras is processed simultaneously. At block 504, feature matching may performed using motion data. At block 506, the feature matched points may be used to render a 3D position of points in the environment.

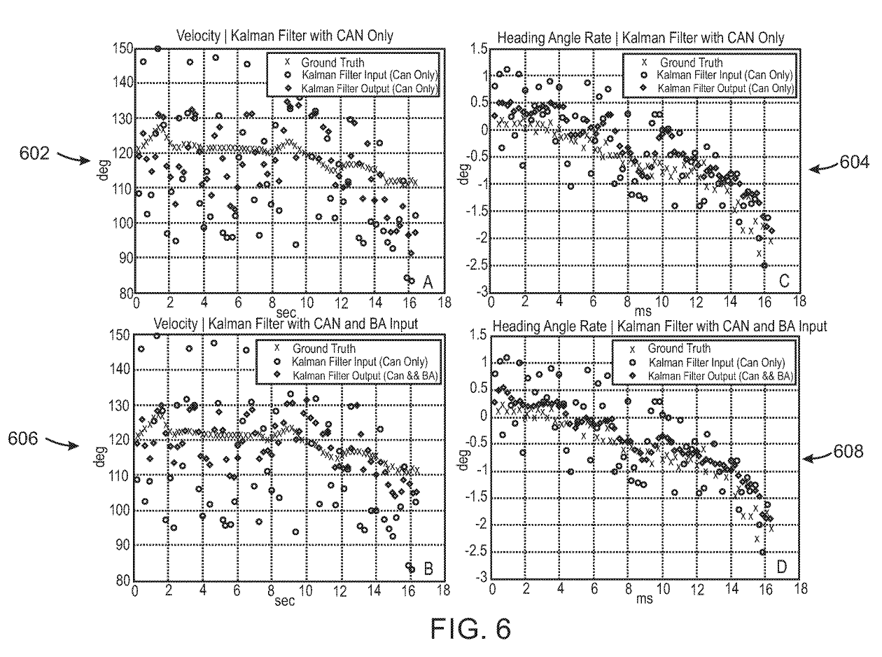

FIG. 6 is an illustration of a plurality of graphs simulating motion. In FIG. 6, the present techniques are evaluated in an environment that is capable of simulating the car movement as well as the surrounded geometry and image renderings from virtual car cameras. In embodiments, the results of motion improvements are shown in FIG. 6. At graph 602, velocity estimation results without CSBA methods are illustrated. The x's represent the ground truth. The circles illustrate the noisy measurements and the diamonds represent the result of the Kalman filter. As illustrated, the estimation is better that the noisy measurements. The results according to the present techniques are even better when the filter results are fused with the with CSBA as illustrated at graph 604. A graph 606 and a graph 608 have similar results but for the heading angle rates.

In embodiments, the 3D deviation between the estimated structure and the virtual geometry in a simulation environment is computed. The deviation may be computed for each point by determining the distance to the shortest surface. The error distribution may be computed to show effectiveness of the present techniques. In embodiments, the present techniques the environment perception significantly.

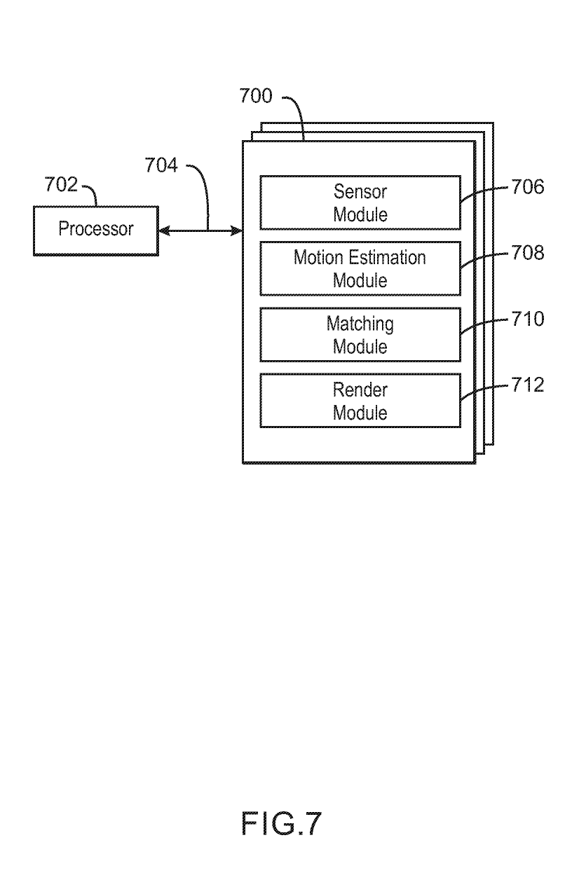

FIG. 7 is a block diagram showing a medium 700 that contains logic for environment perception using a surrounding monitoring system. The medium 700 may be a computer-readable medium, including a non-transitory medium that stores code that can be accessed by a processor 702 over a computer bus 704. For example, the computer-readable medium 700 can be volatile or non-volatile data storage device. The medium 700 can also be a logic unit, such as an Application Specific Integrated Circuit (ASIC), a Field Programmable Gate Array (FPGA), or an arrangement of logic gates implemented in one or more integrated circuits, for example.

The medium 700 may include modules 706-712 configured to perform the techniques described herein. For example, a sensor module 706 may be configured to capture sensor data. The sensor module 706 may include a sensor hub. A motion estimation module 708 may be configured to estimate motion based on sensor data and data from a plurality of cameras. A matching module 710 may be configured to perform feature matching of 3D points. A render module 712 may be configured to render a surrounding environment based on the 3D points. In some embodiments, the modules 706-712 may be modules of computer code configured to direct the operations of the processor 702.

The block diagram of FIG. 7 is not intended to indicate that the medium 700 is to include all of the components shown in FIG. 7. Further, the medium 700 may include any number of additional components not shown in FIG. 7, depending on the details of the specific implementation.

Example 1 is an apparatus for environment perception using a monitoring system. The apparatus includes a plurality of sensors, wherein the plurality of sensors is to collect data; a controller to estimate motion based on the data and data from a plurality of cameras, wherein the data from the plurality of cameras is processed simultaneously; a matching unit to perform feature matching using the motion estimation; and a perception unit to determine a 3D position of points in the environment based on the feature matching.

Example 2 includes the apparatus of example 1, including or excluding optional features. In this example, the points are used to render a 3D structure estimation.

Example 3 includes the apparatus of any one of examples 1 to 2, including or excluding optional features. In this example, the plurality of sensors includes velocity, steering wheel change rate or yaw rate sensors.

Example 4 includes the apparatus of any one of examples 1 to 3, including or excluding optional features. In this example, sensor data is fused to determine a rough motion, and the rough motion is refined using a CSBA.

Example 5 includes the apparatus of any one of examples 1 to 4, including or excluding optional features. In this example, the estimated motion is converted to all camera motions and is used during feature matching.

Example 6 includes the apparatus of any one of examples 1 to 5, including or excluding optional features. In this example, apparatus of claim 1, the controller is to estimate motion using a Kalman filter.

Example 7 includes the apparatus of any one of examples 1 to 6, including or excluding optional features. In this example, the 3D position of points in the environment is provided to the matching unit in a feedback loop.

Example 8 includes the apparatus of any one of examples 1 to 7, including or excluding optional features. In this example, feature matching includes filtering outliers from a plurality of points.

Example 9 includes the apparatus of any one of examples 1 to 8, including or excluding optional features. In this example, the plurality of cameras form a rigid system.

Example 10 includes the apparatus of any one of examples 1 to 9, including or excluding optional features. In this example, data collected from the plurality of sensors is obtained from vehicle odometery sensors.

Example 11 is a method for environment perception using a monitoring system. The method includes collecting vehicle sensor data; fusing the sensor data with camera based motion estimation data; feature matching a series of images from a plurality of cameras to estimate a 3D structure; performing bundle adjustment of the plurality of cameras simultaneously; fusing the bundle adjustment data with the sensor data and the camera based motion estimation data; and determining a 3D position of points in the environment using the bundle adjustment data.

Example 12 includes the method of example 11, including or excluding optional features. In this example, the points are used to render a 3D structure estimation.

Example 13 includes the method of any one of examples 11 to 12, including or excluding optional features. In this example, the vehicle sensor data includes velocity data, steering wheel change rate data, or yaw rate data.

Example 14 includes the method of any one of examples 11 to 13, including or excluding optional features. In this example, vehicle sensor data is fused to determine a rough motion and the rough motion is refined using a CSBA.

Example 15 includes the method of any one of examples 11 to 14, including or excluding optional features. In this example, a Kalman filter is used to fuse the sensor data with camera based motion estimation data and to fuse the bundle adjustment data with the sensor data and the camera based motion estimation data.

Example 16 includes the method of any one of examples 11 to 15, including or excluding optional features. In this example, the feature matching is applied to a frame sequence from each camera of a plurality of camera.

Example 17 includes the method of any one of examples 11 to 16, including or excluding optional features. In this example, the 3D position of points in the environment is used to fusing a feedback loop.

Example 18 includes the method of any one of examples 11 to 17, including or excluding optional features. In this example, feature matching includes filtering outliers from a plurality of points.

Example 19 includes the method of any one of examples 11 to 18, including or excluding optional features. In this example, the plurality of cameras form a rigid system.

Example 20 includes the method of any one of examples 11 to 19, including or excluding optional features. In this example, performing bundle adjustment results in an additional measurement vector that is combined with the sensor data and the camera based motion estimation data.

Example 21 is a system for environment perception. The system includes a display; a plurality of cameras; a plurality of sensors to obtain vehicle sensor data; a memory that is to store instructions and that is communicatively coupled to the display, the plurality of cameras, and the plurality of sensors; and a processor communicatively coupled to the display, the plurality of cameras, the plurality of sensors, and the memory, wherein when the processor is to execute the instructions, the processor is to: fuse the sensor data with camera based motion estimation data; match features from images from the plurality of cameras to estimate a 3D structure; perform a bundle adjustment of the plurality of cameras simultaneously; fuse the bundle adjustment data with the sensor data and the camera based motion estimation data; and determine a 3D position of points in the environment using the bundle adjustment data.

Example 22 includes the system of example 21, including or excluding optional features. In this example, the points are used to render a 3D structure estimation.

Example 23 includes the system of any one of examples 21 to 22, including or excluding optional features. In this example, a feature matched pair of points is triangulated to estimate the 3D structure.

Example 24 includes the system of any one of examples 21 to 23, including or excluding optional features. In this example, matching features from images from the plurality of cameras to estimate a 3D structure comprises multiple image frames from each camera of the plurality of cameras. Optionally, the system includes generating an observation point for each frame of the multiple image frames corresponding to the 3D structure; projecting a line segment for each observation point onto a latest frame to generate a matching point candidate for each frame of the multiple image frames; and averaging the matching point candidates from each frame of the multiple image frames.

Example 25 includes the system of any one of examples 21 to 24, including or excluding optional features. In this example, a feature matched pair of points is triangulated to estimate the 3D structure, where triangulation comprises: determining a projection of a second point to an epipolar line, where the feature matched pair of points includes a first point from a first frame, and the second point from a second frame; determining a projection matrix from the first frame to the second frame; calculating an intersection Rx using the projection matrix.

Example 26 includes the system of any one of examples 21 to 25, including or excluding optional features. In this example, the estimated motion is converted to all camera motions and is used during feature matching.

Example 27 includes the system of any one of examples 21 to 26, including or excluding optional features. In this example, the 3D position of points in the environment is fused with the bundle adjustment data, the sensor data, and the camera based motion estimation data in an iterative fashion.

Example 28 includes the system of any one of examples 21 to 27, including or excluding optional features. In this example, feature matching includes filtering outliers from a plurality of points.

Example 29 includes the system of any one of examples 21 to 28, including or excluding optional features. In this example, the plurality of cameras form a rigid system.

Example 30 is a tangible, non-transitory, computer-readable medium. The computer-readable medium includes instructions that direct the processor to collect vehicle sensor data; fuse the sensor data with camera based motion estimation data; feature match a series of images from a plurality of cameras to estimate a 3D structure; perform bundle adjustment of the plurality of cameras simultaneously; fuse the bundle adjustment data with the sensor data and the camera based motion estimation data; and determine a 3D position of points in the environment using the bundle adjustment data.

Example 31 includes the computer-readable medium of example 30, including or excluding optional features. In this example, the points are used to render a 3D structure estimation.

Example 32 includes the computer-readable medium of any one of examples 30 to 31, including or excluding optional features. In this example, the vehicle sensor data includes velocity data, steering wheel change rate data, or yaw rate data.

Example 33 includes the computer-readable medium of any one of examples 30 to 32, including or excluding optional features. In this example, vehicle sensor data is fused to determine a rough motion and the rough motion is refined using a CSBA.

Example 34 includes the computer-readable medium of any one of examples 30 to 33, including or excluding optional features. In this example, a Kalman filter is used to fuse the sensor data with camera based motion estimation data and to fuse the bundle adjustment data with the sensor data and the camera based motion estimation data.

Example 35 includes the computer-readable medium of any one of examples 30 to 34, including or excluding optional features. In this example, the feature matching is applied to a frame sequence from each camera of a plurality of camera.

Example 36 includes the computer-readable medium of any one of examples 30 to 35, including or excluding optional features. In this example, the 3D position of points in the environment is used to fusing a feedback loop.

Example 37 includes the computer-readable medium of any one of examples 30 to 36, including or excluding optional features. In this example, feature matching includes filtering outliers from a plurality of points.

Example 38 includes the computer-readable medium of any one of examples 30 to 37, including or excluding optional features. In this example, the plurality of cameras form a rigid system.

Example 39 includes the computer-readable medium of any one of examples 30 to 38, including or excluding optional features. In this example, performing bundle adjustment results in an additional measurement vector that is combined with the sensor data and the camera based motion estimation data.

Example 40 is an apparatus for environment perception using a monitoring system. The apparatus includes instructions that direct the processor to a plurality of sensors, wherein the plurality of sensors is to collect data; a means to estimate motion based on the data and data from a plurality of cameras, wherein the data from the plurality of cameras is processed simultaneously; a means to feature match based on the motion estimation; and a perception unit to determine a 3D position of points in the environment based on the feature matching.

Example 41 includes the apparatus of example 40, including or excluding optional features. In this example, the means to feature match is to match features across a plurality of frames from each camera of the plurality of cameras. Optionally, the apparatus includes generating an observation point for each frame of the plurality of frames corresponding to a 3D structure; projecting a line segment for each observation point onto a latest frame to generate a matching point candidate for each frame of the plurality of frames; and averaging the matching point candidates from each frame of the plurality of frames.

Example 42 includes the apparatus of any one of examples 40 to 41, including or excluding optional features. In this example, the points are used to render a 3D structure estimation.

Example 43 includes the apparatus of any one of examples 40 to 42, including or excluding optional features. In this example, the plurality of sensors includes velocity, steering wheel change rate or yaw rate sensors.

Example 44 includes the apparatus of any one of examples 40 to 43, including or excluding optional features. In this example, sensor data is fused to determine a rough motion, and the rough motion is refined using a CSBA.

Example 45 includes the apparatus of any one of examples 40 to 44, including or excluding optional features. In this example, the estimated motion is converted to all camera motions and is used by the means to feature match.

Example 46 includes the apparatus of any one of examples 40 to 45, including or excluding optional features. In this example, apparatus of claim 41, the means to estimate is to estimate motion using a Kalman filter.

Example 47 includes the apparatus of any one of examples 40 to 46, including or excluding optional features. In this example, the 3D position of points in the environment is provided to the means to feature match in a feedback loop.

Example 48 includes the apparatus of any one of examples 40 to 47, including or excluding optional features. In this example, the means to feature match includes filtering outliers from a plurality of points.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for environment perception using a monitoring system, comprising:
a plurality of sensors, wherein the plurality of sensors is to collect data;
a controller to estimate motion based on the data and data from a plurality of cameras, wherein the data from the plurality of cameras is processed simultaneously;
a matching unit to perform feature matching using the motion estimation; and
a perception unit to determine a 3D position of points in the environment based on the feature matching.

2. The apparatus of claim 1, wherein the points are used to render a 3D structure estimation.

3. The apparatus of claim 1, wherein the plurality of sensors includes velocity, steering wheel change rate or yaw rate sensors.

4. The apparatus of claim 1, wherein sensor data is fused to determine a rough motion, and the rough motion is refined using a CSBA.

5. The apparatus of claim 1, wherein the estimated motion is converted to all camera motions and is used during feature matching.

6. The apparatus of claim 1, the controller is to estimate motion using a Kalman filter.

7. The apparatus of claim 1, wherein the 3D position of points in the environment is provided to the matching unit in a feedback loop.

8. The apparatus of claim 1, wherein feature matching includes filtering outliers from a plurality of points.

9. The apparatus of claim 1, wherein the plurality of cameras form a rigid system.

10. The apparatus of claim 1, wherein data collected from the plurality of sensors is obtained from vehicle odometery sensors.

11. A method for environment perception using a monitoring system, comprising:
collecting vehicle sensor data;
fusing the sensor data with camera based motion estimation data;
feature matching a series of images from a plurality of cameras to estimate a 3D structure;
performing bundle adjustment of the plurality of cameras simultaneously;
fusing the bundle adjustment data with the sensor data and the camera based motion estimation data; and
determining a 3D position of points in the environment using the bundle adjustment data.

12. The method of claim 11, wherein the points are used to render a 3D structure estimation.

13. The method of claim 11, wherein the vehicle sensor data includes velocity data, steering wheel change rate data, or yaw rate data.

14. The method of claim 11, wherein vehicle sensor data is fused to determine a rough motion and the rough motion is refined using a CSBA.

15. A system for environment perception, comprising:
a display;
a plurality of cameras;
a plurality of sensors to obtain vehicle sensor data;
a memory that is to store instructions and that is communicatively coupled to the display, the plurality of cameras, and the plurality of sensors; and
a processor communicatively coupled to the display, the plurality of cameras, the plurality of sensors, and the memory, wherein when the processor is to execute the instructions, the processor is to:
fuse the sensor data with camera based motion estimation data;
match features from images from the plurality of cameras to estimate a 3D structure;
perform a bundle adjustment of the plurality of cameras simultaneously;
fuse the bundle adjustment data with the sensor data and the camera based motion estimation data; and
determine a 3D position of points in the environment using the bundle adjustment data.

16. The system of claim 15, wherein the points are used to render a 3D structure estimation.

17. The system of claim 15, wherein a feature matched pair of points is triangulated to estimate the 3D structure.

18. The system of claim 15, wherein matching features from images from the plurality of cameras to estimate a 3D structure comprises multiple image frames from each camera of the plurality of cameras.

19. The system of claim 18, comprising:
generating an observation point for each frame of the multiple image frames corresponding to the 3D structure;
projecting a line segment for each observation point onto a latest frame to generate a matching point candidate for each frame of the multiple image frames; and
averaging the matching point candidates from each frame of the multiple image frames.

20. The system of claim 15, wherein a feature matched pair of points is triangulated to estimate the 3D structure, where triangulation comprises:
determining a projection of a second point to an epipolar line, where the feature matched pair of points includes a first point from a first frame, and the second point from a second frame;
determining a projection matrix from the first frame to the second frame;
calculating an intersection Rₓ using the projection matrix.

21. A tangible, non-transitory, computer-readable medium comprising instructions that, when executed by a processor, direct the processor to:
collect vehicle sensor data;
fuse the sensor data with camera based motion estimation data;
feature match a series of images from a plurality of cameras to estimate a 3D structure;
perform bundle adjustment of the plurality of cameras simultaneously;
fuse the bundle adjustment data with the sensor data and the camera based motion estimation data; and
determine a 3D position of points in the environment using the bundle adjustment data.

22. The computer readable medium of claim 21, wherein a Kalman filter is used to fuse the sensor data with camera based motion estimation data and to fuse the bundle adjustment data with the sensor data and the camera based motion estimation data.

23. The computer readable medium of claim 21, wherein the feature matching is applied to a frame sequence from each camera of a plurality of camera.

24. The computer readable medium of claim 21, wherein the 3D position of points in the environment is used to fusing a feedback loop.

25. The computer readable medium of claim 21, wherein feature matching includes filtering outliers from a plurality of points.
